(19) United States
(12) Patent Application Publication
(10) Pub. No.: US 2008/0178243 A1
(43) Pub. Date: Jul. 24, 2008

(54) Multimedia client/server system with audio synchronization and methods for use therewith

(76) Inventors: SuiWu Dong, Markham (CA); Song Jin, Richmond Hill (CA)

Correspondence Address: GARLICK HARRISON & MARKISON, P.O. BOX 160727, AUSTIN, TX, 78716-0727, US

(21) Appl. No.: 11/655,544

(22) Filed: Jan. 19, 2007

(51) Int. Cl. H04N 7/173

(52) U.S. Cl. 725/116

(57) ABSTRACT

A multimedia server module that is coupleable to a plurality of multimedia sources that produce at least one video signal and an associated audio signal includes an encoder module that encodes the at least one video signal to produce an encoded video signal. An RF server transceiver module transmits a server signal that includes the encoded video signal over a wireless communication path, receives a client signal from a client module over the wireless communication path and demodulates the client signal to produce a video timing signal. An audio processing module produces an audio output from the audio signal having a time delay, wherein the time delay is based on the video timing signal.

### TECHNICAL FIELD OF THE INVENTION

This invention relates generally to wireless communication systems and more particularly to in-home local area networking for content such as multimedia.

### BACKGROUND OF THE INVENTION

With the number of households having multiple television sets increasing, and many users wanting the latest and greatest video viewing services, many households have multiple satellite receivers, cable set-top boxes, modems, et cetera. For in-home Internet access, each computer or Internet device has its own Internet connection. As such, each computer or Internet device includes a modem.

As an alternative, an in-home wireless local area network (LAN) may be used to provide Internet access and to communicate multimedia information to multiple devices within the home. In such an in-home local area network, each computer or Internet device includes a network card to access a server. The server provides the coupling to the Internet. The in-home wireless local area network can also be used to facilitate an in-home computer network that couples a plurality of computers with one or more printers, facsimile machines, as well as to multimedia content from a digital video recorder, set-top box, broadband video system, etc.

When transmitting realtime signals such as video with associated audio, the audio signal must be synchronized with the video in order for proper display and reproduction. This can provide challenges when the audio and video are reproduced by separate devices.

### BRIEF DESCRIPTION OF THE DRAWINGS

FIG. 1 presents a pictorial representation of a multimedia client server system in accordance with an embodiment of the present invention.

FIG. 2 presents a pictorial representation of a multimedia client/server system in accordance with an embodiment of the present invention.

FIG. 3 presents a block diagram representation of a multimedia client/server system 10 in accordance with an embodiment of the present invention.

FIG. 4 presents a block diagram representation of a multimedia server module 12 in accordance with an embodiment of the present invention.

FIG. 5 presents a block diagram representation of a client module 200 in accordance with an embodiment of the present invention.

FIG. 6 presents a block diagram representation of an audio processing module 175 in accordance with an embodiment of the present invention.

FIG. 7 presents a block diagram representation of a server clock 390 in accordance with an embodiment of the present invention.

FIG. 8 presents a block diagram representation of an audio processing module 175 in accordance with an embodiment of the present invention.

FIG. 9 presents a flow chart representation of a method in accordance with an embodiment of the present invention.

### DETAILED DISCUSSION OF A PREFERRED EMBODIMENT

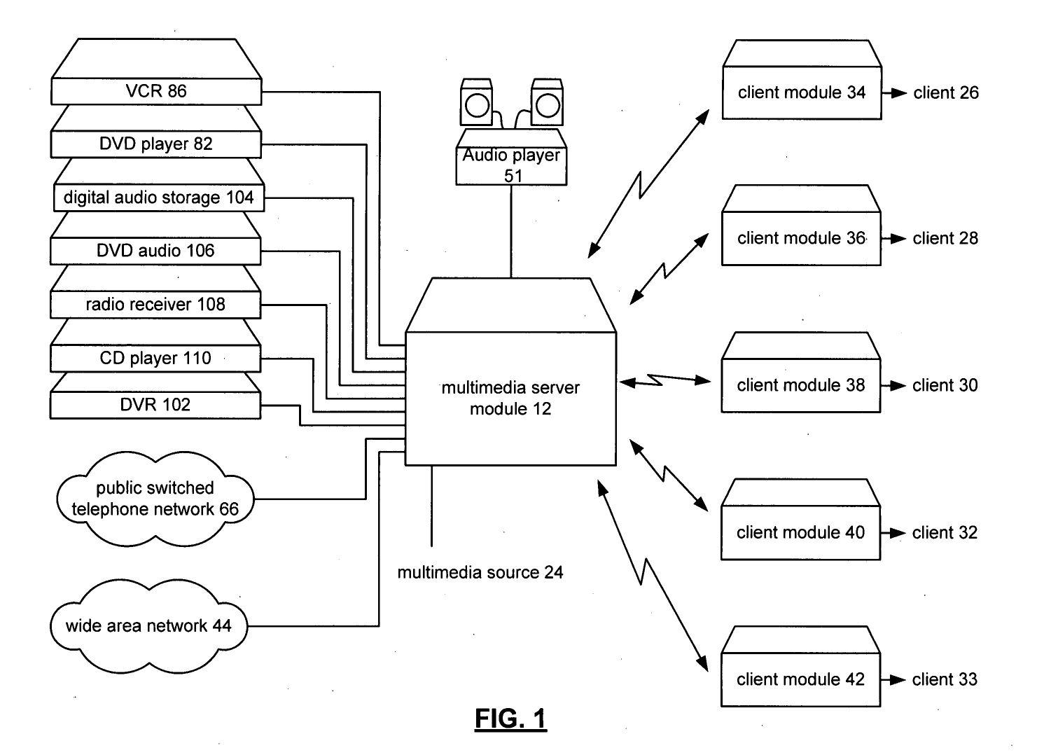

FIG. 1 presents a pictorial representation of a multimedia client server system in accordance with an embodiment of the present invention. The multimedia client server system includes multimedia server module 12, client modules 34, 36, 38, 40 and 42 that are coupled to clients 26, 28, 30, 32, and 33, and a plurality of multimedia sources. The multimedia sources include video cassette recorder (VCR) 86, digital video disk (DVD) player 82, digital video recorder (DVR) 102, digital audio storage device 104, DVD audio 106, radio receiver 108, CD player 110, public switch telephone network 66, wide area network 44 (such as a private network, public network, satellite network, cable network and/or the Internet) for accessing broadcast, stored or streaming audio, video and/or other multimedia content and/or any other type of audio, video and/or multimedia source 24.

In an embodiment of the present invention, the clients 26, 28, 30, 32 and 33 may select playback from, and/or connection to, any one of the multimedia sources. The selection request from each client module would identify the desired multimedia source, the client, the desired service and any other information to assist the multimedia server module 12 in processing the request. As such, one client may be accessing the Internet, while another client is watching a satellite broadcast channel, while another is listening to a CD playback, while another is talking on the telephone, and yet another is watching a DVD playback. This is all done via the multimedia server module 12 without requiring the clients to have direct access to the multimedia sources and without the requirement that each client have its own multimedia source and/or multimedia source connection.

In addition, audio player 51, such as a home stereo system, home theatre system or other audio playback device, is coupled to multimedia server module 12 to provide audio playback at the server. In accordance with the present invention, the audio output generated by the multimedia server module to audio player 51 can be from a multimedia source having synchronized audio and video playback. For instance, when a DVD movie is selected for playback by one of the client modules, the audio programming that is associated with the movie can be reproduced at the audio player 51 while the video is displayed by the particular client that is associated with that client module that selected it. In this fashion, the audio player 51 and video client can be located separately, such as in separate areas of a room or separate areas of a home to accommodate more flexible multimedia configurations.

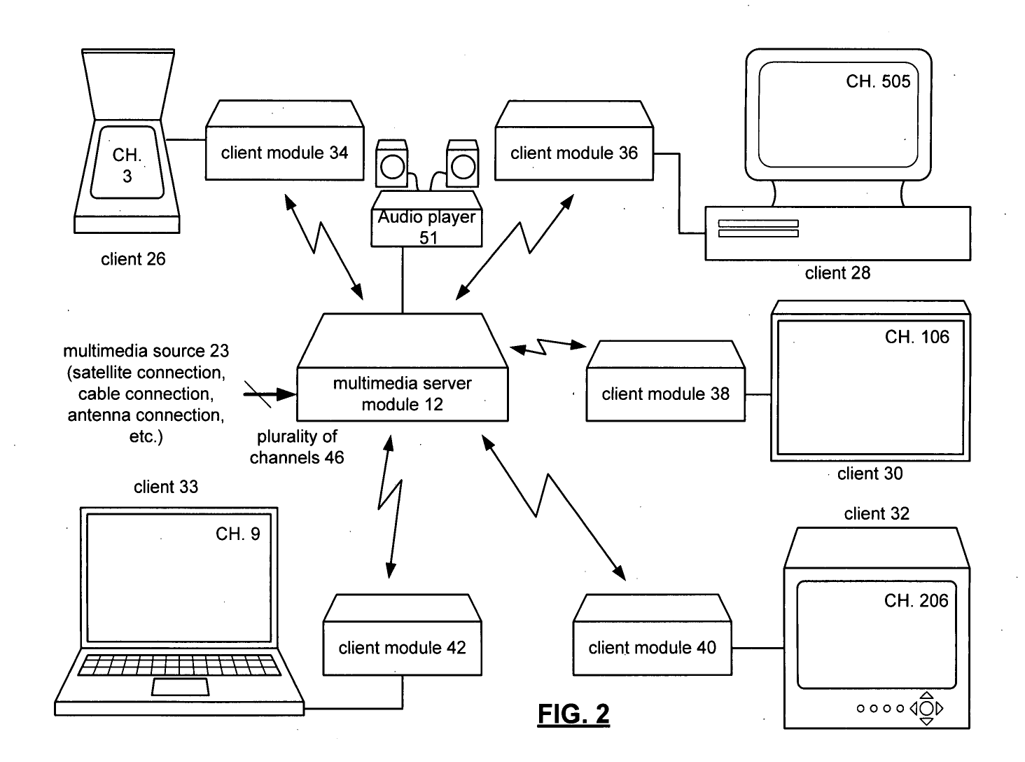

The multimedia server module 12 and one or more of the client modules 34, 36, 38, 40 and 42 include one or more features for synchronizing the audio output to audio player 51 with an associated video signal sent to one or more of the client modules 26, 28, 30, 32 and 33 in accordance with the present invention, as will be described in greater detail in the Figures that follow, and in particular, with reference to FIGS. 2-9.

FIG. 2 presents a pictorial representation of a multimedia client/server system in accordance with an embodiment of the present invention. In particular, a multimedia client/server system includes a multimedia server module 12, a plurality of client modules 34, 36, 38, 40 and 42 that are operably coupled to a plurality of clients 26, 28, 30, 32 and 33. The multimedia server module 12 is operably coupled to receive a plurality of channels 46 from a multimedia source 23. The multimedia source 23 can be a broadcast, stored or steaming multimedia signal, from a video cassette recorder (VCR) 86, digital video disk (DVD) player 82, digital video recorder (DVR) 102 digital audio storage device 104, DVD audio 106, radio receiver 108, CD player 110, public switch telephone network 66, wide area network 44 (such as a private network, public network, satellite network, cable network and/or the Internet for accessing broadcast, stored or streaming audio, video and/or other multimedia content) and/or any other type of audio, video and/or multimedia source 24. As one of average skill in the art will appreciate, the multimedia server module 12 may be a stand-alone device, may be incorporated in a satellite receiver, set-top box, cable box, HDTV tuner, home entertainment receiver, audio player 51, et cetera. In addition, the multimedia server module 12 may be implemented using discrete components, integrated circuits, and/or a combination thereof.

The multimedia server module 12 communicates with the plurality of client modules 34, 36, 38, 40, and 42 via a radio frequency communication path. As such, the multimedia server module 12 and each of the client modules 34, 36, 38, 40 and 42 each include a transceiver that operates to send and receive data via the communication path.

As shown, each client module is operably coupled to one of the clients. For example, client module 34 is operably coupled to client 26, which is representative of a personal digital assistant. Client module 36 is operably coupled to client 28, which is representative of a personal computer. Client module 38 is operably coupled to client 30, which is representative of a monitor (e.g., LCD monitor, flat panel monitor, CRT monitor, et cetera). Such a monitor may include speakers, or a speaker connection, control functions including channel select, volume control, picture quality, et cetera. Client module 40 is operably coupled to client 32, which may be a television set, high definition television (HDTV), standard definition television (SDTV), a home theatre system, et cetera. Client module 42 is operably coupled to client 33, which is representative of a laptop computer.

As one of average skill in the art will appreciate, each client module may be a separate device from its associated client or embedded within the client. In addition, one of average skill in the art will further appreciate that the client modules 34, 36, 38, 40 and 42 may be implemented utilizing discrete components and/or integrated circuits.

In an embodiment of the present invention, each of the clients, via its associated client module, selects one or more channels from the plurality of channels 46. As shown, client 26 has selected channel 3 of the plurality of channels for viewing. Accordingly, client module 34 relays the channel selection of channel 3 to the multimedia server module 12. The multimedia server module 12 selects channel 3 from the plurality of channels 46. The data corresponding to channel 3 is then time multiplexed with the data for the other channels and transmitted from the multimedia server module 12 to each of the client modules 34, 36, 38, 40 and 42. Client module 34 monitors the transmission from the multimedia server module 12 and extracts the data corresponding to channel 3. The extracted data for channel 3 is then provided to the client 26 for display.

Client module 36, 38, 40 and 42 perform a similar function for their associated clients 28, 30, 32 and 25, respectively. As shown, client 28 has selected channel 505, client 30 has selected channel 106, client 32 has selected channel 206 and client 25 has selected channel 9. The client modules 36, 38, 40 and 42 provide the channel selection of its respective client to the multimedia server module 12. Multimedia server module 12 extracts the selected channels from the plurality of channels for each selection request, multiplexes the data for each of the selected channels (for this example channel 3, 9, 106, 206 and 505) into a stream of data. The stream of data is then transmitted to each of the client modules. Each client module extracts the appropriate data of the selected channel for its respective client. For example, client module 36 monitors the transmitted data for data related to channel 505, client module 38 monitors for data related to channel 106, client module 40 monitors the transmission for data related to channel 206 and client module 42 monitors the transmission for data related to channel 9.

From each client's prospective, the client 26, 28, 30, 32 and 33 has independent access to the multimedia source 23. Accordingly, client 26 may at any time change its channel selection from, for example, channel 3 to channel 120. The client module 34 provides the channel selection request which may be the absence of acknowledgements to the multimedia server module 12, which now retrieves data related to channel 120 for client 36 as opposed to channel 3. As an alternate embodiment, the functionality of client modules 34, 36, 38, 40 and 42 may vary. For example, client module 34 may not provide all the independent functionality that client module 36 does. For example, client module 34 may not have independent channel selection capabilities but only selecting channels that one of the other clients have selected. Alternatively, one client module may service a plurality of clients.

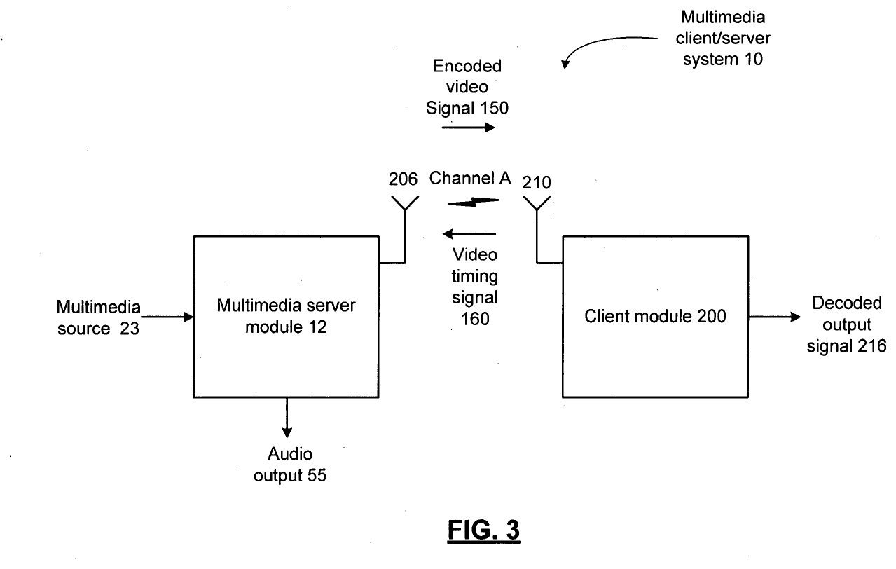

FIG. 3 presents a block diagram representation of a multimedia client/server system 10 in accordance with an embodiment of the present invention. In particular, the multimedia client/server system 10 includes multimedia server module 12 that transmits a multimedia signal 214, such as a broadcast, stored or streaming signal selected from multimedia sources 23. Multimedia server module 12 generates an encoded video 150 that contains the multimedia content from one or more of the multimedia sources 23 and transmits, via antenna 206, a radio frequency (RF) signal. This RF signal, a server signal that includes encoded video signal 150, is transmitted at a carrier frequency corresponding to a channel such as channel A of an RF spectrum over a wireless communication path to one or more client modules such as client module 200. Client module 200, (such as client modules 34, 36, 38, 40 and 42) receives the RF signal via antenna 210 and produces a decoded output signal 216. In addition, client module 200 generates its own RF signal, a client signal that includes video timing signal 160 that relates to the timing of decoded output signal 216 sent to an associated client device for display. This RF signal is transmitted back to the multimedia server module 12 over the wireless communication path, for use by the multimedia server module 12 in synchronizing the audio output 55 supplied to an audio player such as audio player 51.

It should be noted that channel A represents a channel of an RF spectrum corresponding to one or more carrier frequencies. This is as opposed to channels 3, 9, 106, 206 and 505 discussed in association with FIG. 2 where “channel”, is this context, was used primarily to denote different streams of multimedia content such as “The Weather Channel”, “The Discovery Channel” or “Gone with the Wind”. In the event that noise, interference or fading hamper the performance of one of the channels, the multimedia server module 12 can switch to a different channel.

In an embodiment of the present invention, the transmitted multimedia content can further be encrypted in the encoding process and decrypted in the decoding process, such as by RSA encryption, WEP, or protected using other secure access protocols such as MAC address filtering, so that if the content is wirelessly received by an authorized client device, the multimedia content can be otherwise protected. Multimedia server module 12 and client module 200 share secure access data during an initialization procedure in order to secure the wireless communications between these two devices.

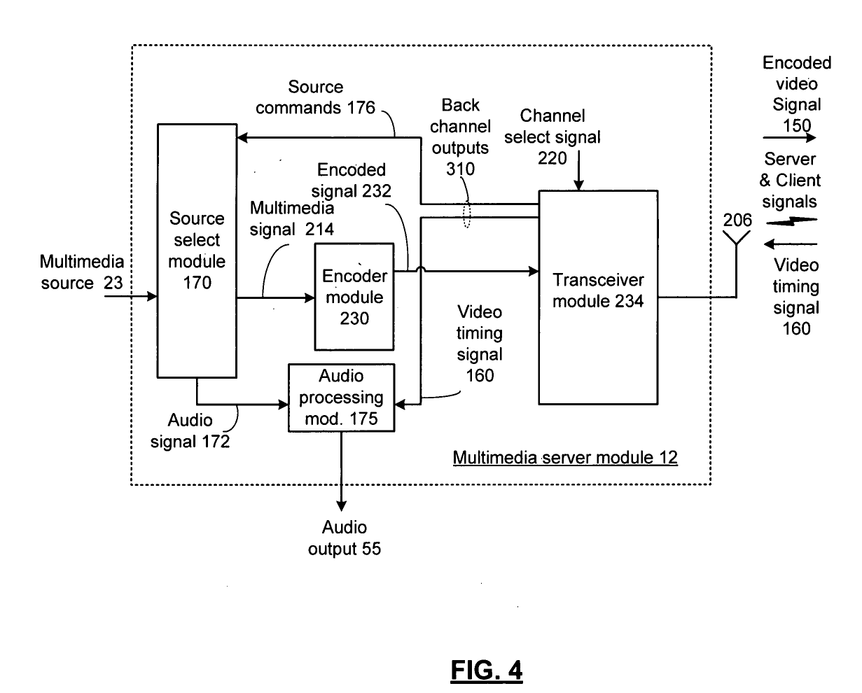

Further functions and features of the multimedia server module 12 and client module 200 including several alternative embodiments are presented in conjunction with FIGS. 4-9 that follow.

FIG. 4 presents a block diagram representation of a multimedia server module 12 in accordance with an embodiment of the present invention. In particular, multimedia server module 12 includes a source select module 170 that passes multimedia content selected by one or more client modules as a multimedia signal 214 and an associated audio signal 172, if associated with the selected multimedia content and optionally selected to be processed as an audio output 55 in response to source commands 176 received from a client module. This source selection module can be implemented with one or more routers, switches or similar devices to select and route the audio, video and other multimedia content from multimedia sources 24 to produce multimedia signal 214.

An encoder module 230 generates an encoded signal 232, such as encoded video signal 150 from an unencoded or encoded multimedia input signal 214. In an embodiment of the present invention, the encoding scheme may be one or more of multilevel, multiphase and multifrequency encoding, non-return to zero encoding, Manchester encoding, block encoding and/or nB/mB encoding wherein n>m. For example, the nB/mB may be 4B/5B encoding where 4 bits of actual data are converted into 5 bits of encoded data.

Encoding may further include compression, transrate and transcode encoding of the multimedia signal based on the content and format of multimedia signal 214 and the bandwidth and performance of channel A. In an embodiment, the multimedia signal 214 includes an analog composite video signal that is formatted in any of a number of video formats including National Television Systems Committee (NTSC), Phase Alternating Line (PAL) or Sequentiel Couleur Avec Memoire (SECAM). The encoded signal 232 may be digitized, compressed, and channel coded for transmission at low data rates in weak channel conditions or higher data rates in stronger channel conditions. Alternatively, multimedia signal 214 can be already in a digital format such as a Motion Picture Experts Group (MPEG) format (such as MPEG1, MPEG2, MPEG4), a Society of Motion Picture and Television Engineers (SMPTE) standard such as VC1, H.264, Quicktime format, Real Media format, Windows Media Video (WMV) or Audio Video Interleave (AVI), or another digital video format, either standard or proprietary. In this case, the encoding performed by encoder module 230 may be limited to encoding of the data for the channel, based on the strength or quality of the channel conditions, with or without further compression.

In an embodiment of the present invention, encoder module 230 generates an encoded signal 232 from the multimedia signal 214 that is in a digital format such as an MPEG, a Society of Motion Picture and Television Engineers (SMPTE) standard such as VC1, H.264, Quicktime format, Real Media format, Windows Media Video (WMV) or Audio Video Interleave (AVI), or another digital video format, either standard or proprietary. Transceiver module 234, in turn, produces RF signal, such as a server signal that includes the encoded video signal 150, and wirelessly transmits the RF signal to a client device, such as through client module 200. In an embodiment of the present invention, encoder module 230 can operate as a transcoder to receive a multimedia signal 214 in a first digital format, decode this signal and re-encode it into a second digital format for transmission. For example, multimedia input 214 can include a compressed MPEG2/4 input. The encoder module 230 operates to decompress the signal and re-encode it in another format, such as H.264. In addition, encoder module 230 can receive a multimedia input signal that is in a digital format such as High-Definition Multimedia Interface (HDMI). The encoder module 230 can compress and encode the digital signal into a compressed digital format.

In an embodiment of the present invention, the non-RF portions of the transceiver module 234 and the encoder module 230 can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital), optionally based on operational instructions that are stored in a memory that may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the transceiver module 234 and/or encoder module 230 implement one or more of its functions via a state machine, analog circuitry, digital circuitry, and/or logic circuitry based on operational instructions, the memory storing the corresponding operational instructions may be embedded within, or external to, the circuitry comprising the state machine, analog circuitry, digital circuitry, and/or logic circuitry.

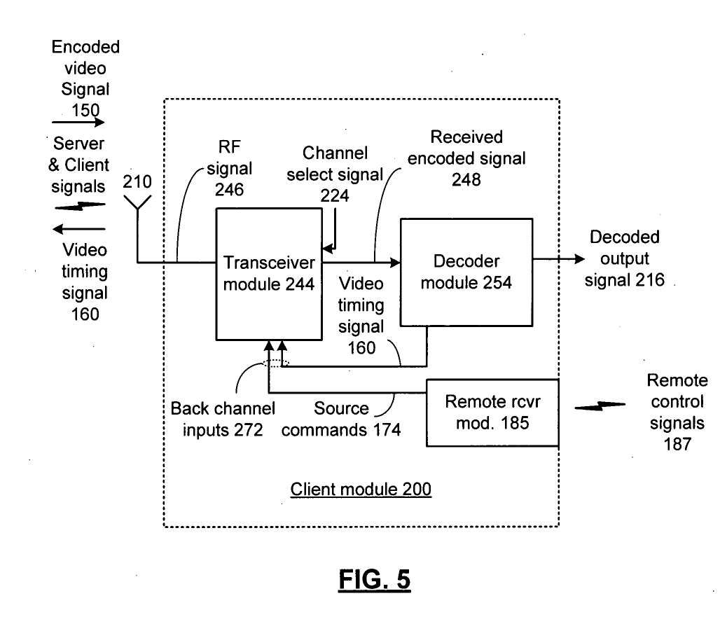

Transceiver module 234 modulates the encoded signal 232 to produce a RF signal that includes multimedia content such as a packetized video signal at a first carrier frequency and transmits the RF signal over channel A using antenna 206. In addition, transceiver module 234 produces back channel output 310, that includes source commands 176 and video timing signal 160, based on an RF signal, such as a client signal received from the client module 200 over channel A. While not expressly shown, multimedia server module 12 can include a decoder module, such as decoder module 254 that will be discussed in conjunction with FIG. 5, for operating the back channel in a similar fashion.

In an embodiment of the present invention, transceiver module 234 is selectively tunable to a plurality of other carrier frequencies in response to channel selection signal 220. For instance, in an implementation of the multimedia server module 12 and client module 200 using wireless transmission link in the United States that conforms with the IEEE 802.11g standard, channel A can be selected as any of the 11 allocated channels. In an embodiment of the present invention, the channel selection signals can be preprogrammed into multimedia server module 12, dynamically chosen based on a site survey that scans the available channels to determine a suitable channel for use, received from the client module 200 or arbitrated between the client module 200 and multimedia server module 12, or selected under user control. Similarly, channel A can be implemented as a channel of a broadband wireless access network that conforms to at least one of the following standards: 802.11a, b, n or other 802.11 standard, Ultra Wideband (UWB), or Worldwide Interoperability for Microwave Access (WiMAX). Transceiver module 234 can secure the RF communication link by optionally encrypting the encoded signal 232, password protecting the data or through other secure access protocol or methodology.

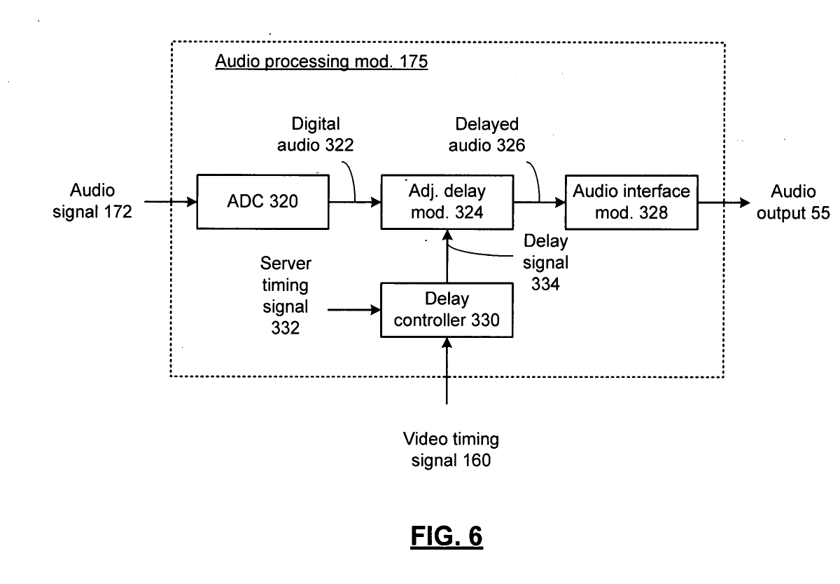

In addition, multimedia server module 12 includes audio processing module 175 that produces audio output 55 from the audio signal 172. In particular, audio processing module 175 adds a time delay to the audio signal 172 during processing that is based on timing feedback from the client module in the form of video timing signal 160. This timing feedback is used by the audio processing module to synchronize the audio output 55 so that audio player 51 reproduces audio in synchronization with the display of the associated video portion of the multimedia content 214 by the client device coupled to the client module 200. Further details regarding the operation of audio processing module 175 are presented in conjunction with FIGS. 6-9 that follow.

FIG. 5 presents a block diagram representation of a client module 200 in accordance with an embodiment of the present invention. In particular, client module 200 includes transceiver module 244 for receiving an RF signal, such as the server signal carrying encoded video signal 150, over channel A or an alternate channel selected by multimedia server module 12 and for converting the RF signal into a received encoded signal 248. In addition, transceiver module 244 is operable to modulate back channel input 272, including for instance, video timing signal 160 and source commands 174 received as remote control signals 187 by remote control receiver module 185 from a remote control device such as an infrared or RF remote control device. In particular, transceiver module 244 produces RF signals, such as the client signal sent to multimedia server module 12 over channel A. While not expressly shown, client module 200 includes an encoder module, such as encoder module 230 for operating the back channel in a similar fashion.

In an embodiment of the present invention, multimedia server module 12 and client module 200 use a wireless transmission link that conforms with the IEEE 802.11g standard that uses a 52-subcarrier orthogonal frequency division multiplexing (OFDM) with a maximum data rate of 54 Mbits/sec. The data rate is reduced in increments in response to adverse channel conditions from 48 mbits/sec, down to as low as 6 Mbits/sec by modifying the modulation and effective coding rate from 64-quadrature amplitude modulation (64-QAM) to binary phase shift keying (BPSK). The 52 subcarriers of a channel are spaced 312.5 kHz apart, where 48 of the subcarriers carry data, and 4 subcarriers carry pilot tones. Received encoded signal 248 can be a baseband signal or a low intermediate frequency (IF) signal.

While transceiver modules 234 and 244 have been presented as RF transceivers, in an embodiment of the present invention, the source commands 174, encoded video signal 150, video timing signal 160, other multimedia content and other command and control information can optionally be sent through a physical electronic connection such as Ethernet, Universal Serial Bus (USB), Personal Computer Interface (PCI), Firewire, or small computer service interface (SCSI), ASI (Asynchronous Serial Interface), or SPI (Serial Peripheral Interface). However, other physical electronic connections, either standard or proprietary may likewise be implemented or used within the broad scope of the present invention.

Client module 200 further includes decoder module 254 for decoding the received encoded signal 248 into a decoded output signal 216, such as in a format used by the attached client. In particular, further decoding of the data can include decompression of a compressed digital signal, formatting of a video signal as in NTSC, PAL, SECAM, etc., and other formatting to match the input format of the client device. As discussed above, transceiver module 244 receives and demodulates RF signal 246 to produce a received encoded signal 248. In addition, decoder module 254 generates video timing signal 160 based on time stamps encoded in the received encoded signal 248 or other timing information. As previously discussed this feedback signal allows the production of any video content included in decoded output signal 216, to be synchronized with the audio output 55 produced by the multimedia server module 12 for local audio player 51.

In an embodiment of the present invention, the non-RF or infrared portions of transceiver module 244, remote control receiver 185 and the decoder module 254 can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital), optionally based on operational instructions that are stored in a memory that may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the transceiver module 244, remote control receiver 185 and or decoder module 254 implement one or more of its functions via a state machine, analog circuitry, digital circuitry, and/or logic circuitry based on operational instructions, the memory storing the corresponding operational instructions may be embedded within, or external to, the circuitry comprising the state machine, analog circuitry, digital circuitry, and/or logic circuitry.

In an embodiment of the present invention, transceiver module 244 is selectively tunable to a plurality of other carrier frequencies in response to channel selection signals 224. For instance, in an implementation of the multimedia server module 12 and client module 200 using wireless transmission link in the United States that conforms with the IEEE 802.11g standard, channel A can be selected as any two of the 11 allocated channels. In an embodiment of the present invention, the channel selection signals can be preprogrammed into client module 200, dynamically chosen based on a site survey that scans the available channels to determine two suitable channels for use, received from the multimedia server module 12 or arbitrated between the client module 200 and multimedia server module 12, or selected under user control.

The description above has been limited to spectrum reserved for 802.11x compliant broadband access networks, in an alternative embodiment of the present invention, other spectrum and other wireless links including Ultra Wideband (UWB), Worldwide Interoperability for Microwave Access (WiMAX) and other wireless links can likewise be implemented.

FIG. 6 presents a block diagram representation of an audio processing module 175 in accordance with an embodiment of the present invention. In this embodiment audio processing module 175 processes an analog audio signal 172. An analog to digital converter 320 converts the audio signal 172 into digital audio 322. Delay controller 330 generates a delay signal 334 based on the video timing signal 160 received from the client module and a locally generated server timing signal 332. Adjustable delay module 324 produces delayed audio 326 by adjustably delaying the digital audio 322 by a time delay that is based on the delay signal 334. An audio interface module 328 is optionally included to produce the audio output 55 in a digital audio format, such as a 20 or 24 bit the Sony/Philipps digital interface format (SPDIF) or other digital audio format. In this embodiment, the adjustable delay module 324 can be implemented with a shift register, buffer or other delay circuit to delay the digital audio 322 by a number of samples that, based on the difference between the local time of server timing signal 332 and the remote time represented by the received video timing signal 160. Further, a delay offset can be added to compensate for the expected or actual delay introduced by the client module 200, wireless communication path, and multimedia server module 12 in producing the video timing signal 160 at the delay controller 330, and producing the delayed audio output 55. It should be noted that the accuracy of the synchronization need only be within an amount that is perceptible by a potential viewer. For instance, a delay of 100 msec or more may be acceptable for some applications, while a smaller delay may be required, based on the particular design considerations and application.

In an alternative embodiment of the present invention, the ADC 320 is implemented instead with an sampling circuit that produces discrete time samples of audio signal 172 that are delayed by adjustable delay module 324, implemented using a bucket-brigade device, tapped delay line, analog shift register, charge coupled device or other similar circuit to process the delay using discrete time, rather than digital signal processing.

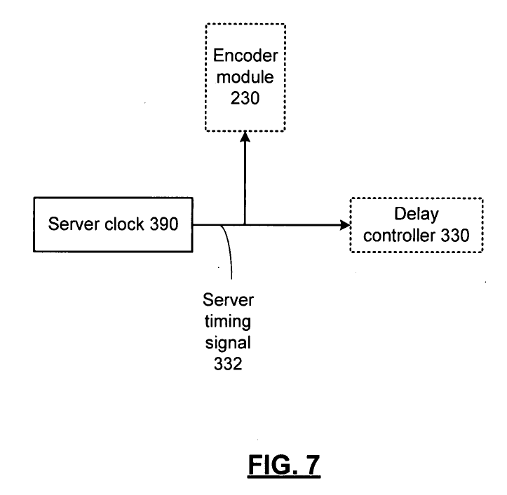

FIG. 7 presents a block diagram representation of a server clock 390 in accordance with an embodiment of the present invention. In particular, server clock 390 presents a time base such as a real-time clock or other clock signal that is used to generate a timing reference to delay controller 330.

In an embodiment of the present invention, the server timing signal 332 is also used to generate time stamps that are periodically encoded in the encoded video signal 150 by the encoder module 230. In this embodiment, these periodic time stamps can be extracted by the decoder module 254 of the client module 200 to generate the video timing signal 160. In operation, this allows the received video timing signal 160 to be compared to the server timing signal 332 that was used to generate this particular time stamp.

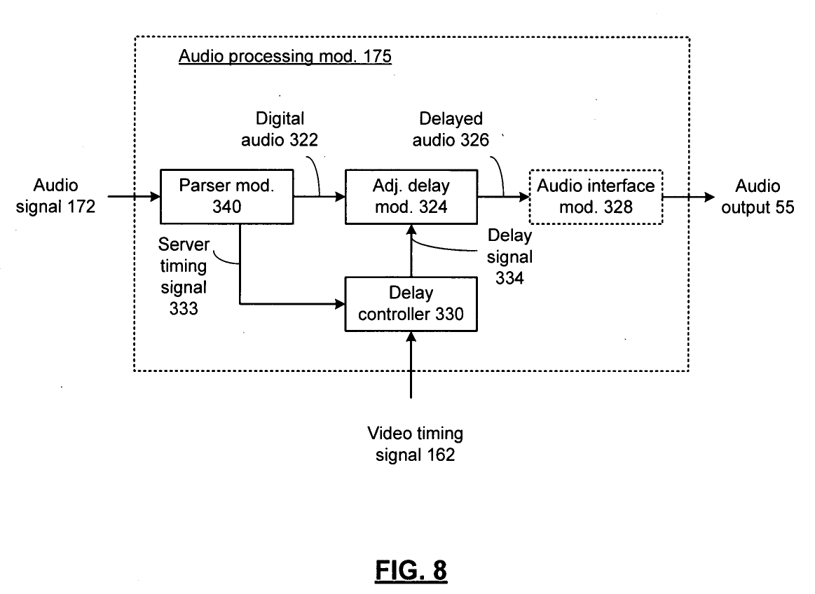

FIG. 8 presents a block diagram representation of an audio processing module 175 in accordance with an embodiment of the present invention. This circuit includes many common elements of the audio processing module descried in conjunction with FIG. 6 with common elements being referred to by common reference numerals. In particular, the audio signal 172 includes a digital audio signal and the audio processing module 175 includes a parser module 340 that generates the server timing signal 333 from the digital audio signal. In this fashion, time stamps or other timing signals present both the audio and video components of the original formatting of the multimedia source content are used for timing synchronization. In this embodiment, encoder module 230 passes the video time stamps or other timing signals of the original formatting in the production of encoded video signal 150. As before, these time stamps or other timing signals are extracted by decoder module 254 to produce video timing signal 160.

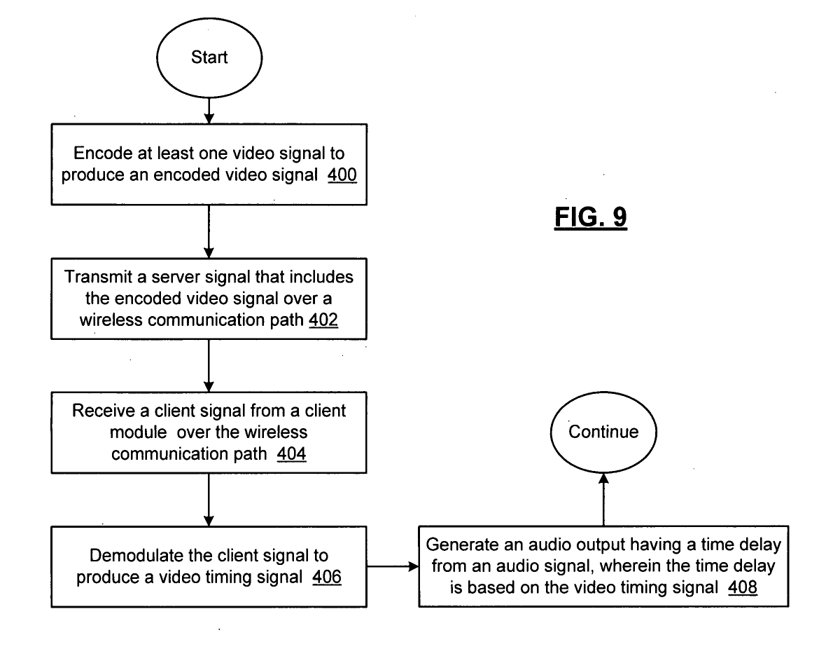

FIG. 9 presents a flow chart representation of a method in accordance with an embodiment of the present invention. In particular, a method is presented for use in conjunction with one or more of the functions and features described in association with FIGS. 1-8. In step 400, at least one video signal is encoded to produce an encoded video signal. In step 402, a server signal is transmitted that includes the encoded video signal over a wireless communication path. In step 404, a client signal is received from a client module over the wireless communication path. In step 406, the client signal is demodulated to produce a video timing signal. In step 408, an audio output is generated from the audio signal having a time delay, wherein the time delay is based on the video timing signal.

In an embodiment of the present invention, step 408 includes generating a delay signal based on the video timing signal and a server timing signal, and generating the time delay based on the delay signal. This delay signal can be generated based on the difference between the video timing signal and the server timing signal and can include a delay offset. Step 408 can further include generating the audio output in a digital audio format from a delayed audio signal. In addition, step 408 can include generating the server timing signal from the digital audio signal. The audio signal can include a digital audio signal and step 408 can include generating the server timing signal from the digital audio signal.

The audio signal can include an analog audio signal and wherein the step 408 can include converting the audio signal into digital audio. In addition, the server timing signal can be generated based on a server clock. Also, the video timing signal can generated based on a time stamp encoded in the encoded video signal. Step 400 can include transcoding the at least one video signal.

In an embodiment of the present invention, the various circuit components are implemented using 0.35 micron or smaller CMOS technology. Provided however that other circuit technologies, both integrated or non-integrated, may be used within the broad scope of the present invention.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to order of magnitude differences. As one of ordinary skill in the art will further appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As the term module is used in the description of the various embodiments of the present invention, a module includes a functional block that is implemented in hardware, software, and/or firmware that performs one or more module functions such as the processing of an input signal to produce an output signal. As used herein, a module may contain submodules that themselves are modules. When implemented in software or firmware, each module can be implemented using a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory. The memory may be a single memory device or a plurality of memory devices. Such a memory device may be a read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

Thus, there has been described herein an apparatus and method, as well as several embodiments including a preferred embodiment, for implementing a multimedia client/server system, multimedia server module, and client module. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A multimedia client/server system comprising:
a multimedia server module, coupleable to a plurality of multimedia sources that produce at least one video signal and an associated audio signal, the multimedia server module including:
an encoder module that encodes the at least one video signal to produce an encoded video signal;
an RF server transceiver module, coupled to the encoder module, that transmits a server signal that includes the encoded video signal over a wireless communication path, that receives a client signal over the wireless communication path and that demodulates the client signal to produce a video timing signal; and
an audio processing module, coupled to the RF transceiver module, that produces an audio output from the audio signal having a time delay, wherein the time delay is based on the video timing signal; and
a client module, coupleable to at least one client device, the client module including:
an RF client transceiver module that receives the server signal over the wireless communication path and demodulates the server signal to produce a received encoded signal; and
a decoder module, coupled to the RF client transceiver module, that decodes the received encoded signal into a decoded output signal and the video timing signal;
wherein the RF client transceiver module transmits the client signal that includes the video timing signal over the wireless communication path.

2. The multimedia client/server system of claim 1 wherein the audio processing module includes a delay controller that generates a delay signal based on the video timing signal and a server timing signal, and an adjustable delay module that generates the time delay based on the delay signal.

3. The multimedia client/server system of claim 2 wherein delay controller generates the delay signal based on the difference between the video timing signal and the server timing signal.

4. The multimedia client/server system of claim 3 wherein delay controller generates the delay signal based on the difference between the video timing signal and the server timing signal and a delay offset.

5. The multimedia client/server system of claim 2 wherein the audio processing module further includes an audio interface module that produces the audio output in a digital audio format from a delayed audio signal produced by the adjustable delay module.

6. The multimedia client/server system of claim 2 wherein the audio signal includes a digital audio signal and the audio processing module further includes a parser that generates the server timing signal from the digital audio signal.

7. The multimedia client/server system of claim 2 wherein the audio signal includes an analog audio signal and the audio processing module further includes an analog to digital converter for converting the audio signal into digital audio.

8. The multimedia client/server system of claim 2 wherein the server timing signal is generated based on a server clock.

9. The multimedia client/server system of claim 2 wherein the video timing signal is generated based on a time stamp encoded in the encoded video signal by the encoder module.

10. The multimedia client/server system of claim 1 wherein the encoder module transcodes the at least one video signal.

11. A multimedia server module, coupleable to a plurality of multimedia sources that produce at least one video signal and an associated audio signal, the multimedia server module including:
an encoder module that encodes the at least one video signal to produce an encoded video signal;
an RF server transceiver module, coupled to the encoder module, that transmits a server signal that includes the encoded video signal over a wireless communication path, that receives a client signal from a client module over the wireless communication path and that demodulates the client signal to produce a video timing signal; and
an audio processing module, coupled to the RF transceiver module, that produces an audio output from the audio signal having a time delay, wherein the time delay is based on the video timing signal.

12. The multimedia server module of claim 11 wherein the audio processing module includes a delay controller that generates a delay signal based on the video timing signal and a server timing signal, and an adjustable delay module that generates the time delay based on the delay signal.

13. The multimedia server module of claim 12 wherein delay controller generates the delay signal based on the difference between the video timing signal and the server timing signal.

14. The multimedia server module of claim 13 wherein delay controller generates the delay signal based on the difference between the video timing signal and the server timing signal and a delay offset.

15. The multimedia server module of claim 12 wherein the audio processing module further includes an audio interface module that produces the audio output in a digital audio format from a delayed audio signal produced by the adjustable delay module.

16. The multimedia server module of claim 12 wherein the audio signal includes a digital audio signal and the audio processing module further includes a parser that generates the server timing signal from the digital audio signal.

17. The multimedia server module of claim 12 wherein the audio signal includes an analog audio signal and the audio processing module further includes an analog to digital converter for converting the audio signal into digital audio.

18. The multimedia server module of claim 12 wherein the server timing signal is generated based on a server clock.

19. The multimedia server module of claim 12 wherein the video timing signal is generated based on a time stamp encoded in the encoded video signal by the encoder module.

20. The multimedia server module of claim 11 wherein the encoder module transcodes the at least one video signal.

21. A method for use in multimedia server module, coupleable to a plurality of multimedia sources that produce at least one video signal and an associated audio signal, the method comprising:
encoding the at least one video signal to produce an encoded video signal;
transmitting a server signal that includes the encoded video signal over a wireless communication path;
receiving a client signal from a client module over the wireless communication path;
demodulating the client signal to produce a video timing signal;
generating an audio output from the audio signal having a time delay, wherein the time delay is based on the video timing signal.

22. The method of claim 21 wherein the step of generating an audio output includes generating a delay signal based on the video timing signal and a server timing signal, and generating the time delay based on the delay signal.

23. The method of claim 22 wherein the delay signal is generated based on the difference between the video timing signal and the server timing signal.

24. The method of claim 22 wherein the delay signal is generated based on the difference between the video timing signal and the server timing signal and a delay offset.

25. The method of claim 22 wherein the step of generating an audio output includes generating the audio output in a digital audio format from a delayed audio signal.

26. The method of claim 22 wherein the audio signal includes a digital audio signal and wherein the step of generating an audio output further includes generating the server timing signal from the digital audio signal.

27. The method of claim 22 wherein the audio signal includes an analog audio signal and wherein the step of generating an audio output further includes converting the audio signal into digital audio.

28. The method of claim 22 wherein the server timing signal is generated based on a server clock.

29. The method of claim 22 wherein the video timing signal is generated based on a time stamp encoded in the encoded video signal.

30. The method of claim 22 wherein the step of encoding includes transcoding the at least one video signal.
